(19) United States
(12) Patent Application Publication
(10) Pub. No.: US 2010/0299922 A1
(43) Pub. Date: Dec. 2, 2010

(54) COOLING DUCT PISTON FOR AN INTERNAL COMBUSTION ENGINE

(75) Inventors: Volker Gniesmer, Alfeld (DE); Norbert Nies, Kulsheim (DE)

Correspondence Address: YOUNG BASILE, 3001 WEST BIG BEAVER ROAD, SUITE 624, TROY, MI, 48084, US

(73) Assignee: KS KOLBENSCHMIDT GMBH, Neckarsulm (DE)

(21) Appl. No.: 12/161,190

(22) PCT Filed: Oct. 18, 2006
(86) PCT No.: PCT/EP2006/010033

§ 371 Date: May 24, 2010

(30) Foreign Application Priority Data
Jan. 21, 2006 (DE) 102006002949.6

(51) Int. Cl. B23P 15/10; F02F 3/22; B21K 1/18

(52) U.S. Cl. 29/888.044; 123/193.6

(57) ABSTRACT

A method for producing a piston for an internal combustion engine, designed as a cooling duct piston for small compression heights. The piston includes a lower part and an upper part which are supported by one or more corresponding joining planes and are connected of a friction welding process. The piston encloses an inner, trough-shaped cooling duct and an outer cooling duct which is axially spaced apart from an annual area. The inner cooling duct is formed in the lower part of the piston by a mechanical machining process, such as a forging process. Transfer openings which are assigned to the cooling ducts are formed before the frictional welding of the joining planes.

### BACKGROUND

The invention relates to a cooling duct piston of steel and the method of its production.

U.S. Pat. No. 6,155,157 discloses a cooling duct piston which comprises two components which can be produced separately from each other and then materially joined by a friction-welding process to create a one-piece cooling duct piston. A narrowly dimensioned annular channel is provided as a cooling duct, spaced apart from the annular area of the piston and open circumferentially towards the piston interior through feed and drain galleries. The cooling duct is sprayed with a cooling medium, such as oil, through a stationary spray nozzle. This relatively easy to implement cooling duct does not permit an adequate cooling effect on the piston because of its localized position.

It would be desirable to realize optimal cooling for highly-stressed steel cooling duct pistons.

### SUMMARY

A method for producing a cooling duct piston cast or forged from steel, of at least two parts connected in at least one joining location by friction welding, which in addition to an outer cooling duct encloses at least one additional inner cooling duct with at least one trough-shaped depression. This trough-shaped partial depression of area of the cooling duct, produced by means of a mechanical machining, forging or casting process, is connected to an outer cooling duct of the piston located axially spaced apart from the annular area through at least one transfer opening. The design of the inner cooling duct, which is trough-shaped in sections, advantageously enlarges the cooling oil cavity and consequently the cooling oil input, whereby the shaker effect of the piston is improved and thus overall the cooling effect of the piston can be significantly increased.

The shape of the sectionally trough-shaped inner cooling duct additionally simplifies the introduction of transfer openings between the cooling ducts, which can be designed as galleries. In accordance with one aspect, the transfer openings between the cooling ducts are formed before the friction welding of the at least one joining plane (three are shown) in the lower part by which the lower part and the upper part is supported. The transfer openings can advantageously open into the area of the trough-shaped depression. The resulting degree of freedom in placing the transfer openings allows a determination of a location for the transfer openings to be made solely from the viewpoint of optimal contact and sufficient volume of the cooling medium. A sufficient clearance can be advantageously maintained to the joining surfaces between the upper part and the lower part.

Based on this spatial clearance, the previously introduced transfer openings are not obstructed by the subsequent friction welding of the at least one joining plane and the resulting weld beads. The cooling ducts integrated in a piston with a short compression height result in an optimal cooling effect over the entire surface of the in-piston combustion bowl. The large-capacity design of the cooling ducts advantageously reduces piston weight. As the result of matched wall thicknesses of the outer and inner cooling ducts, which are enlarged around the trough-shaped expansion above the piston pin bore, a structurally solid piston is realized which can withstand the most extreme requirements and can be economically produced.

One configuration of the cooling ducts provides for the coding ducts to extend into the areas of the highest thermal load on the piston. The inner cooling duct which is trough-shaped in sections has a vertically aligned section in the area of the piston pin bore which an angled rotationally-symmetrical section adjoins at one end, aligned diagonally to an axis of symmetry of the piston. This diagonally running section of the inner cooling duct follows and is spaced apart from a contour of the combustion chamber bowl of the piston. The outer cooling duct adjoins the inner cooling duct radially on the outside. A longitudinal extension of the outer cooling duct located at a parallel distance to the piston annular area rises above a longitudinal dimension of the annular area. The cooling ducts are placed in the piston in such a way that they are surrounded by walls of almost equal wall thickness. For the purpose of simplified machining and production, particularly in the case of short compression heights, all of the transfer openings assigned to the cooling ducts can be formed in the lower part of the piston.

In another aspect, a method of producing a cooling duct piston of steel with a central internal cooling space includes a pressure rolling procedure. In a dome-shaped central inner area of the piston formed in the manner of a trough by means of mechanical machining in conjunction with a cover element, an inner cooling space or an inner cooling duct is formed to which a radially offset outer cooling duct is assigned. The production process for the piston provides for transfer openings for the cooling oil, which can also be designated as feed galleries, to be formed between the cooling ducts prior to the final pressure rolling procedure. The pressure rolling procedure is used to bring the piston annular area into its final position by bending.

A cover element or formed part which closes the inner area in the downward direction to create an inner cooling space can also be provided. To this end, a cover element shaped like a disc or pot can be used. In order to secure the cover element, a suitable positive-fit and/or interference-fit attachment, for example, a press fitting can be used. As an alternative, a welded or soldered connection can be used to attach the cover element which encloses at least one outlet for the cooling medium.

A method is known for manufacturing a forged crown of a two-part piston in which one procedural step includes the bending of the annular section into a final position. This piston only has a narrowly designed cooling duct located on the outside, which provides only a localized and thus inadequate cooling effect for large areas of the piston. As an example, in the case of the known piston, there is no directed cooling medium contact in the area of the inner combustion bowl.

Diverging from this, the construction of the present piston allows an optimal cooling effect. By way of a cooling duct or cooling space which follows the shape of a central trough, in conjunction with the radially outwardly located cooling duct, all thermally highly stressed zones of the piston are reached by cooling ducts. By means of the pressure rolling procedure in conjunction with the arrangement of the cooling ducts, a structurally strong steel piston can be achieved with an optimized cooling effect covering, specifically, the entire piston crown. The present piston can withstand extreme loads and can be employed in internal combustion engines with high power density.

The present piston and method of manufacturing the piston simplifies, or optimizes, production of the piston, in particular, the forming of the transfer openings which can be designed as galleries. The production of the galleries in previous steel pistons required increased manufacturing costs. As a result of the more difficult accessibility inside the piston, the galleries, which always ran diagonally, could only be produced using long drill bits. The present method offers great freedom in design for locating the transfer openings originating from the internal cooling duct or the internal cooling space and opening into the outer cooling duct. The location, orientation and number of the transfer openings can be advantageously selected solely with respect to improved cooling medium contact with the cooling duct in order to achieve an optimal cooling effect on the piston.

In a further aspect of the piston, in order to create the inner cooling space, the central inner area towards the piston pin bore which follows the shape of the bowl has a circumferential groove which acts as a holding space for the cooling medium. The annular groove can be created by means of mechanical machining.

In accordance with a further aspect, to create the steel cooling duct piston which encloses an upper part and a lower part, a pressure rolling procedure is used which is combined with at least one main welded joint. This procedure includes the following steps. After an inner cooling duct or an inner cooling space is formed in the piston, the corresponding joining areas by which the upper part and the lower part are supported are welded together. Friction welding can be used. Then transfer openings are introduced which connect the inner cooling duct to the outer cooling duct. As an option, transfer openings can be introduced before the welding. Using a forming process, a pressure rolling procedure, the piston annular area is finally brought into its final location by bending.

### DETAILED DESCRIPTION OF THE DRAWING

The following description explains different aspects of cooling duct pistons in which:

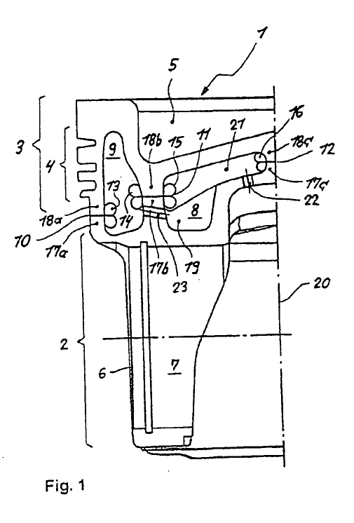

FIG. 1 is a cross sectional view of a first aspect of a cooling duct piston;

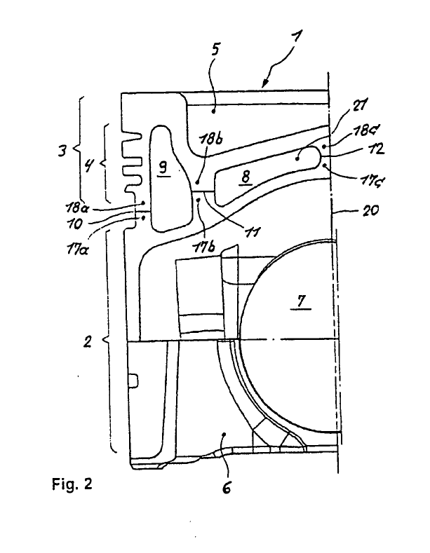

FIG. 2 shows the cooling duct piston from FIG. 1 rotated by 90°;

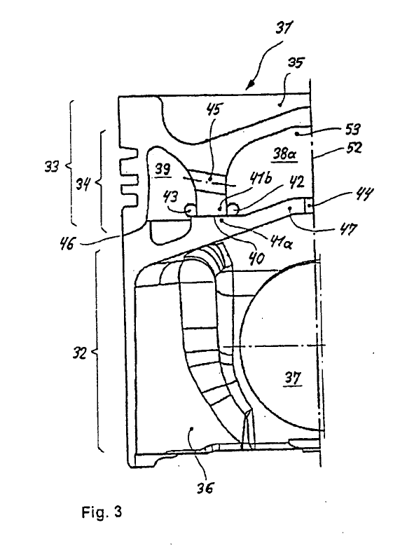

FIG. 3 is a cross sectional view of a second aspect of a cooling duct piston;

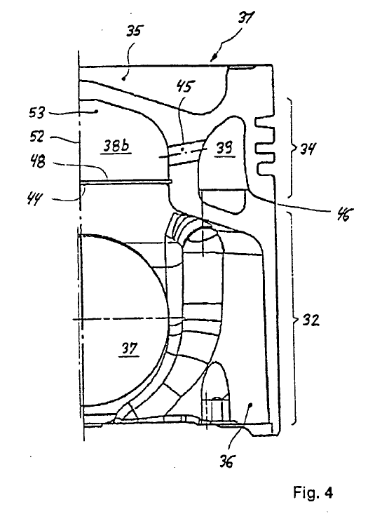

FIG. 4 is a cross sectional view of a third aspect of a cooling duct piston;

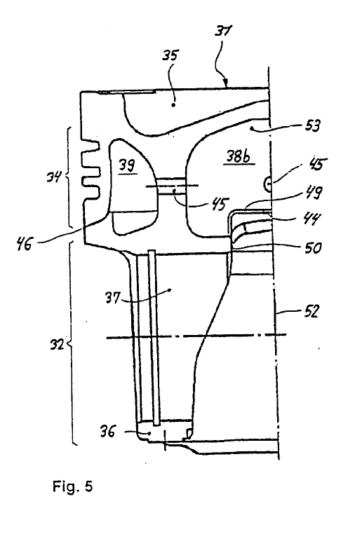

FIG. 5 is a cross sectional view of a fourth aspect of a cooling duct piston;

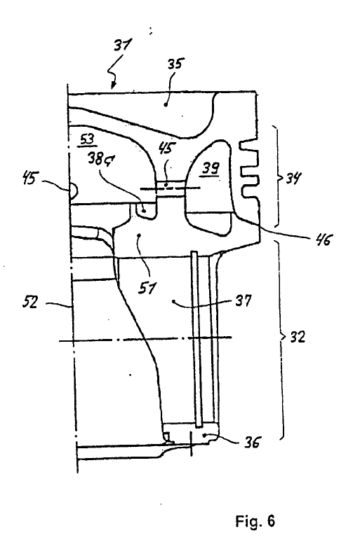

FIG. 6 is a cross sectional view of a fifth aspect of a cooling duct piston; and

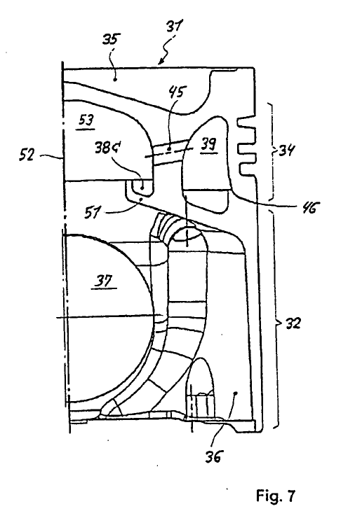

FIG. 7 shows the piston from FIG. 6 rotated by 90°.

### DETAILED DESCRIPTION

FIGS. 1 and 2 show in a half-section view a piston 1 for an internal combustion engine designed as a cooling duct piston which is formed of a lower part 2 and an upper part 3. The piston 1 further includes an annular area 4 for three piston rings, a combustion chamber bowl 5, a piston skirt 6 and a piston pin bore 7. After the lower part 2 and the upper part 3 have been joined, the piston 1 forms an inner cooling duct 8 and an outer cooling duct 9. The lower part 2 and the upper part 3 are supported by three joining planes 10, 11, 12, offset to each other both axially and radially which are connected by means of a friction-welding procedure to create one structural unit, a different number of joining planes also being conceivable.

Clarifying the welding, welding beads 13, 14, 15, 16 are shown in each joining plane 10, 11, 12 pointing in the direction of the cooling ducts 8, 9. Through a cooperation of joining areas 17a, 17b, 17c of the lower part 2 with corresponding joining areas 18a, 18b, 18c of the upper part 3, the individual joining planes 10, 11, 12 are formed which simultaneously surround the cooling ducts 8, 9 in the piston 1. The outer bottle-shaped cooling duct 9 has a longitudinal extension rising above the annular area 4. The trough-shaped structure of the inner cooling duct 8, as shown in FIG. 1, forms a vertical section 19 in the area of the piston pin bore 7 which an angled section 21 running diagonally to an axis of symmetry axis 20 of the piston 1 adjoins on the end side. Outside the area above the piston pin bore, the cooling duct 8 is restricted to the section 21 which runs axially spaced from and following the contour of the combustion bowl 5. To supply the cooling medium, transfer openings 22, 23 are assigned to the cooling ducts 8, 9 which extend partially in the lower part 2 and the upper part 3. Close to the axis of symmetry 20, the cooling duct 8 has a transfer opening 22 which is also designated as a discharge opening. A further transfer opening 23 joining cooling duct 8 to cooling duct 9 is formed in an intermediate wall below the joining plane 11.

The construction and the production method of the piston 1 allow the transfer openings 22, 23 to be made before the friction welding of lower part 2 and upper part 3, which simplifies the introduction of the transfer openings 22, 23. The position and the number of transfer openings 22 is not restricted and can be selected almost as needed in accordance with the requirements regarding contact with the cooling medium. The position and the number of transfer openings 23 is restricted to the trough-shaped depression 19. As shown in FIGS. 1 and 2, the cooling ducts 8, 9 are enclosed by walls of almost equal thickness. This measure advantageously improves the dissipation of heat and optimizes the structural strength of the piston 1.

FIGS. 3 to 7 show a piston 31 which is an alternate design to the piston 1 from FIGS. 1 and 2.

To manufacture the piston 31 in accordance with FIG. 3, an inner cooling space 38a is first formed in a central inner area 53 of the upper part 33. An inner wall of the cooling space 38a runs spaced apart from the contour of the combustion bowl 35. Further, at least one transfer opening 45 joining the cooling space 38a to the cooling duct 39 is introduced into a wall bounding the inner cooling space 38a. As an alternative to the slanted, rising transfer opening 45 shown, the transfer opening can be made in any shape or position. The lower part 32 and the upper part 33 each have a joining area 41a, 42b which together form a joining plane 40 through which both parts are connected by means of friction welding.

Because of sufficient clearance to the joining plane 40, the transfer opening 45 is not affected by the weld beads 42, 43 resulting from the friction welding. After the welding is completed, the annular area 34 is bent from a swung-out position—not shown in FIG. 3—into its final position in which a circumferential surface of the annular area 34 runs concentrically with the axis of symmetry 52 of the piston 31 and which, at the same time, matches the outer contour of the piston skirt 36. The annular area 34 thereby bounds the outer cooling duct 39 on the outside. The pressure rolling procedure ensures a seal of an arcuate join 46 which results between the annular area 34 and the piston skirt 36. The inner cooling space 38a is bounded in the downward direction, looking towards the piston pin bore 37, by a floor 47 connected as one piece to the lower part 32. To admit cooling medium to the cooling space 38a, the floor 47 is provided with at least one central transfer opening 44.

In accordance with FIG. 4, the piston 31 does not have a joining plane. In an intermediate stage of the production process, not shown, the annular area 34 is pivoted away so the transfer opening 45 can be introduced without a special tool before the bending in of the annular area takes place. To delimit the inner cooling space 38b downward, a disc-shaped cover element 48, which can be made of sheet metal, is provided which is permanently attached to the piston wall by means of welding or clamping. For the purpose of admitting cooling medium, at least one transfer opening 44 is provided in the cover element 48.

FIG. 5 shows the piston 31 which, in contrast to FIG. 4, encloses a pot-shaped cover element 49 and closes off the inner cooling space 38b. The cover element 49, which can be advantageously produced in a non-cutting deep draw process, is assigned to an upper hub area 50 of the piston 31. Welding or brazing is a suitable method of attachment or alternatively a clamped joint to form a positive fit between the cover element 49 and the hub 50.

In accordance with FIG. 6, the piston 31 includes an inner cooling duct 38c which is can be produced mechanically. An annular duct is introduced into the upper hub area and in the area 51 perpendicular to it which is open towards the combustion bowl 35. FIG. 7 shows the piston 31 from FIG. 6 in a half-section drawing rotated by 90° which makes clear that the area 51 and, consequently, the cooling duct 38c, is located circumferentially. FIGS. 6 and 7 further show the piston 31 with differently aligned transfer openings 45.

1. A method for producing a piston for an internal combustion comprising the steps of:
forming at least two cooling ducts, which enclose a lower part and an upper part supported by at least one corresponding joining plane and connected by means of a joining process;
forming, in an area above a piston pin bore, the at least two cooling ducts including an inner cooling duct produced by one of a mechanical machining, forging and casting having a trough-shaped area, and an outer cooling duct which is spaced apart from an annular area of the piston;
forming the inner cooling duct with at least one transfer opening to the outer cooling duct which opens into the trough-shaped area of the inner cooling duct and at least one transfer opening which opens into the interior of the piston; and
forming of the at least one transfer openings before the joining of the at least one joining plane.

2. The method of claim 1 further comprising the step of:
connecting the upper part and the lower part by exactly three corresponding joining planes by a joining process, where walls of the joining planes form partial areas of the walls of the inner and outer cooling ducts.

3. the method of claim 1 further comprising the step of:
aligning the trough-shaped partial area of the inner cooling duct almost vertically with a piston bore and an angled section adjoining on the end side of the partial area, aligned diagonally to an axis of symmetry of the piston.

4. claim, :
locating the inner and outer cooling ducts partially in the lower part and partially in the upper part of the piston.

5. , ;
enclosing the inner and outer cooling ducts enclosed by walls of almost equal wall thickness.

6. , :
disposing the inner and outer cooling ducts in a spaced apart manner in the piston following a contour of a combustion bowl.

7. , assigning or the transfer openings to the inner and outer cooling ducts to the lower part of the piston.

8. A method for producing a single-piece, forged, cooling duct piston from steel for an internal combustion engine comprising the steps of:
forming the piston to enclose at least one outer and one inner cooling duct;
forming the piston to enclose an annular area which is brought into a final position by bending;
forming by means of a mechanical machining process, and in conjunction with a cover element in an internal area of the piston, one of an inner cooling space and an inner cooling duct to which the radially spaced apart outer cooling duct is assigned; and
connecting the outer cooling duct to the inner cooling duct inner cooling space by at least one transfer opening.

9. The method of claim 8, further comprising the steps of:
enclosing the piston by a lower part and an upper part;
forming at least one of the inner cooling duct and the inner cooling space;
welding at least one joining plane between the lower part and the upper part;
introducing at least one transfer opening which connects one of the inner cooling space and the inner cooling duct to the outer cooling duct; and
bending the annular area into a final position.

10. The method of claim 8 further comprising the step of:
enclosing by a circumferential collar on the dome-shaped inner area a groove forming the inner cooling duct.

11. The method of claim 8 further comprising the step of:
to form the inner cooling space, forming the inner area of the piston pointing to a piston pin bore bounded by a cover element installed in the piston with at least one transfer opening.

12. The method of claim 11, further comrpsing the step of:
attaching the cover element one of a positive fit, and a non-positive material connection.

13. The method of claim 11,
disposing a cover element having one of a disk-like shape and a pot shape to close off the inner cooling space.

14. The method of claim 8, further comprising the step of:
forming the outer cooling duct with a longitudinal extension rising above the annular area.
